(19) United States
(12) Patent Application Publication
(10) Pub. No.: US 2005/0128128 A1
(43) Pub. Date: Jun. 16, 2005

(54) Real-time object motion detection system and related method

(75) Inventors: Lih-Shang Lo, Jubei City (TW); Hung-Ta Hsu, Hsinchu City (TW); Tung-Tsai Liao, Hsinchu City (TW)

Correspondence Address: BACON & THOMAS, PLLC, 625 SLATERS LANE, FOURTH FLOOR, ALEXANDRIA, VA, 22314, US

(73) Assignee: Sunplus Technology CO., Ltd., Hsinchu (TW)

(21) Appl. No.: 10/898,246

(22) Filed: Jul. 26, 2004

(30) Foreign Application Priority Data
Dec. 15, 2003 (TW) 092135404

(51) Int. Cl. G01S 13/58

(52) U.S. Cl. 342/28; 342/52; 342/109; 342/114; 342/127

(57) ABSTRACT

A real-time object motion detection system includes a first object and a second object in relative movement, wherein: the first object sequentially sends a plurality of signal pairs at continuous time points, every signal pair comprising a first signal and a corresponding second signal, and a first propagation speed of the first signal is faster than a second propagation speed of the second signal; and the second object receives the plurality of first signals and second signals, wherein after receiving one first signal, the second object starts to count until receiving the corresponding second signal to obtain a time difference, and then utilizes the time difference to calculate a relative movement distance and speed.

### BACKGROUND OF THE INVENTION

1. Field of the Invention

The present invention relates to a real-time object motion detection system and a related method.

2. Description of the Related Art

Currently, real-time object motion detection systems (such as a ball velocity detection device) mainly utilize CCD cameras, ultrasonic sensors or lasers for detection. However, these types of detecting devices are very expensive, and as such are typically only available to a small cross-section of the public.

The propagation speed of electromagnetic waves equals the speed of light, whereas the speed of ultrasonic waves is much slower than the speed of light. Therefore, determining how to utilize the speed difference between electromagnetic waves and ultrasonic waves to obtain motion information of an object is a relatively important endeavor.

Therefore, it is desirable to provide a real-time object motion detection system and related method to mitigate and/or obviate the aforementioned problems.

### SUMMARY OF THE INVENTION

An objective of the present invention is to provide a real-time object motion detection system and related method that reduces manufacturing costs.

In accordance with one aspect of the present invention, there is provided a real-time object motion detection system which includes a first object and a second object in relative movement, wherein: the first object sequentially sends a plurality of signal pairs at continuous time points, every signal pair comprising a first signal and a corresponding second signal, and a first propagation speed of the first signal is faster than a second propagation speed of the second signal; and the second object receives the plurality of first signals and second signals, wherein after receiving one first signal, the second object starts to count until receiving the corresponding second signal to obtain a time difference, and then utilizes the time difference to calculate a relative movement distance and speed.

In accordance with another aspect of the present invention, there is provided a moving objecting detection method for detecting relative motion information between a first object and a second object, which includes the steps of: (A) the first object sequentially sending a plurality of signal pairs at continuous time points, every signal pair comprising a first signal and a corresponding second signal, and a first propagation speed of the first signal being faster than a second propagation speed of the second signal; (B) the second object receiving the plurality of first signals and second signals, wherein after receiving one first signal, the second object starts to count until receiving the corresponding second signal to obtain a time difference; and (C) the second object utilizing the time difference to calculate the motion information.

Other objects, advantages, and novel features of the invention will become more apparent from the following detailed description when taken in conjunction with the accompanying drawings.

### BRIEF DESCRIPTION OF THE DRAWINGS

FIG. 1 is a function block drawing of a moving object in accordance with a first embodiment of the present invention.

FIG. 2 is a function block drawing of a fixed object in accordance with the first embodiment of the present invention.

FIG. 3 is a flowchart of a method of the present invention.

FIG. 4 is a message flow chart in accordance with the present invention.

FIG. 5 is a function block drawing of a moving object in accordance with a second embodiment of the present invention.

FIG. 6 a function block drawing of a fixed object in accordance with the second embodiment of the present invention.

### DETAILED DESCRIPTION OF THE PREFERRED EMBODIMENT

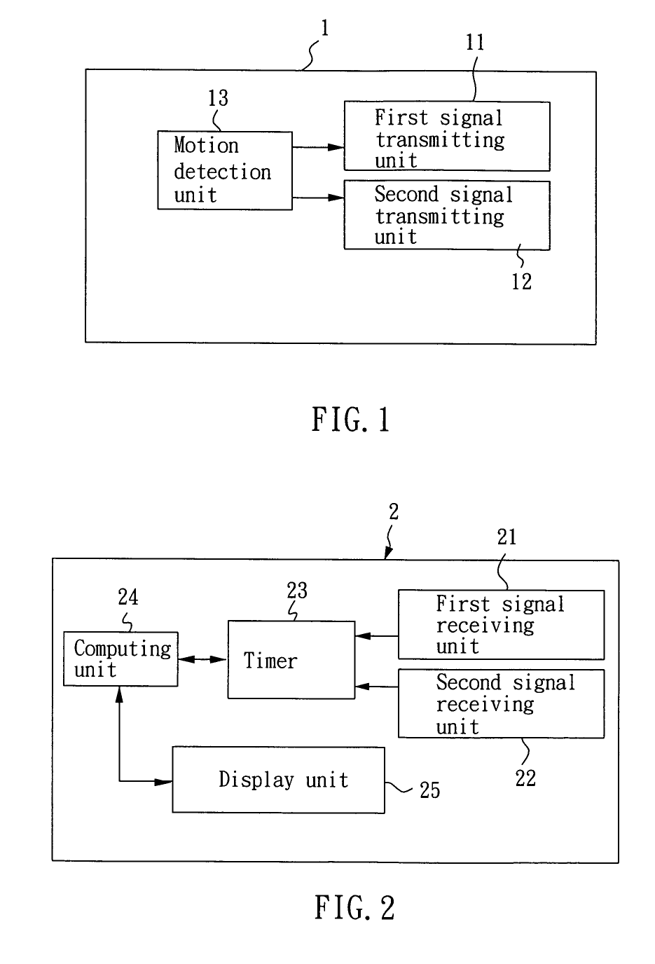

Please refer to FIG. 1. FIG. 1 is a function block drawing of a moving object according to a first embodiment of the present invention. The moving object 1 comprises a first signal transmitting unit 11, a second signal transmitting unit 12 and a motion detection unit 13. The motion detection unit 13 is used for detecting whether or not the moving object 1 is moving. If the object 1 is in motion, the first signal transmitting unit 11 and the second signal transmitting unit 12 are switched on to send respective signals; otherwise, the first signal transmitting unit 11 and the second signal transmitting unit 12 are disabled so as to place the moving object 1 into a power saving mode.

The first signal transmitting unit 11 is an RF transmitter for sending a plurality of first signals; the first signals are sent by way of electromagnetic waves. The second signal transmitting unit 12 is an ultrasonic transmitter for sending a plurality of second signals; the second signals are sent by way of ultrasonic waves. When the moving object 1 is moving, the first signal transmitting unit 11 and the second signal transmitting unit 12 respectively send the first signal and the second signal, and every first signal corresponds with one second signal. In other words, the first signal and the second signal are transmitted at the same time, and every first signal and every second signal has time information which is encoded and used for distinguishing the first signal and the second signal. In this embodiment, the moving object is a ball.

Please refer to FIG. 2. FIG. 2 is a function block drawing of a fixed object according to the first embodiment of the present invention. The fixed object 2 comprises a first signal receiving unit 21, a second signal receiving unit 22, a timer unit 23, a computing unit 24 and a display unit 25. The first signal receiving unit 21 is used for receiving first signals, and the second signal receiving unit 22 is used for receiving second signals. The timer unit 23 starts to count when the first signal receiving unit 21 receives a first signal, and stops counting when the second signal receiving unit 22 receives the corresponding second signal. In this embodiment, the timer unit 23 is capable of counting time for a plurality of signal pairs (including the first and second signals). Alternatively, a plurality of timer units 23 may also be used for counting time for the plurality of signal pairs.

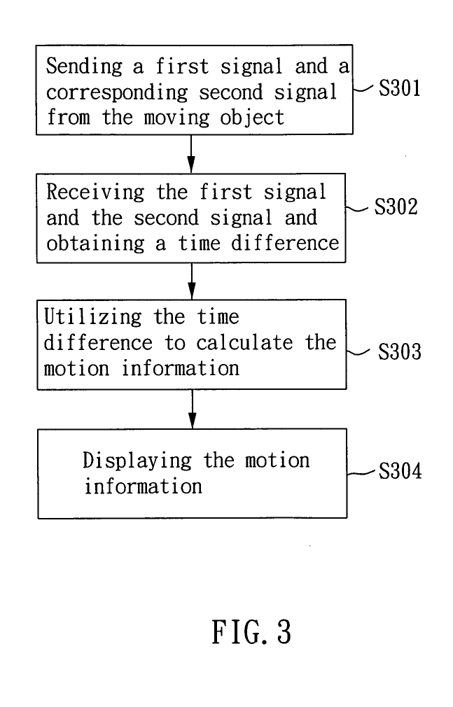

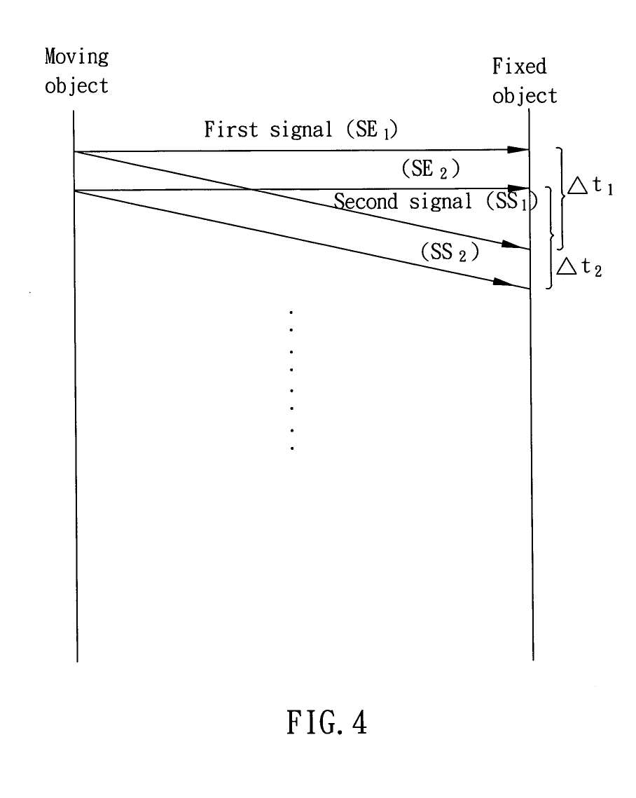

Please refer to FIG. 3 and FIG. 4. FIG. 3 is a flowchart of a method of the present invention. FIG. 4 is a message flow chart according to the present invention. When the moving object 1 is thrown out, it sequentially sends a plurality of signal pairs at continuous time points tᵢ (where i=1, 2, 3 . . . ). Every signal pair includes a first signal SEᵢ and a second signal SSᵢ (step 301). At time t₁, the moving object 1 simultaneously sends the first signal SE₁ and the second signal SS₁, after which the first signal receiving unit 21 receives the first signal SE₁ of the first signal pair and the timer unit 23 is consequently activated to count. The propagation speed of the electromagnetic wave equals the speed of light, and the propagation speed of the electromagnetic wave is much faster than the propagation speed of the ultrasonic wave. Therefore, the corresponding second signal SS₁ arrives at the fixed object 2 later than the first signal SE₁. When the second signal receiving unit 22 receives the corresponding second signal SS₁ of the first signal pair, the timer unit 23 stops counting to obtain the time difference Δt₁ of the signal pair. By this method, at continuous time points t₂, t₃, t₄, . . . , the first signal receiving unit 21 and the second signal receiving unit 22 receive a plurality of first signals SEᵢ and second signals SSᵢ (i=2, 3, 4 . . . ) as signal pairs, and the timer unit 23 counts time for the plurality of signal pairs until the moving object 1 stops (step 302), obtaining a plurality of time differences Δtᵢ (i=2, 3, 4 . . . ).

The computing unit 24 reads the time differences Δtᵢ, and obtains motion information including a relative distance between the moving object 1 and the fixed object 2 and the speed of the moving object 1 by utilizing the following equations:
Lᵢ=V′×tᵢ,
and
V=(Lᵢ−Lᵢ₋₁)/Δtᵢ,
wherein Lᵢ is a distance between the first object 1 and the second object 2 at time tᵢ, V′ is a transmission speed of the second signal (an ultrasonic wave), Δtᵢ is a time difference determined by the timer unit 23 at time tᵢ, and V is a speed of the first object 1 (step 303).

After the above-mentioned calculations, the distances between the moving object 1 and the fixed object 2, and the speed of the moving object 1 at continuous time points (tᵢ, i=1, 2, 3 . . . ), are obtained, and this motion information can be displayed on the display unit 25, or be summarized and displayed at a predetermined time after the moving object 1 comes to a stop.

According to the above description, the present invention utilizes the moving object to send a plurality of first signals by way of electromagnetic waves, and second signals by way of ultrasonic waves, to the fixed object. When the fixed object first receives the first signals sent along the electromagnetic waves, the timer unit starts to count, and when the fixed object receives second signals sent along the ultrasonic waves the timer unit stops counting, thereby obtaining a time difference. Next, the computing unit calculates the motion information of the moving object according to the time differences and a speed of the ultrasonic wave. Therefore, the present invention provides a simple detection system that reduces manufacturing costs.

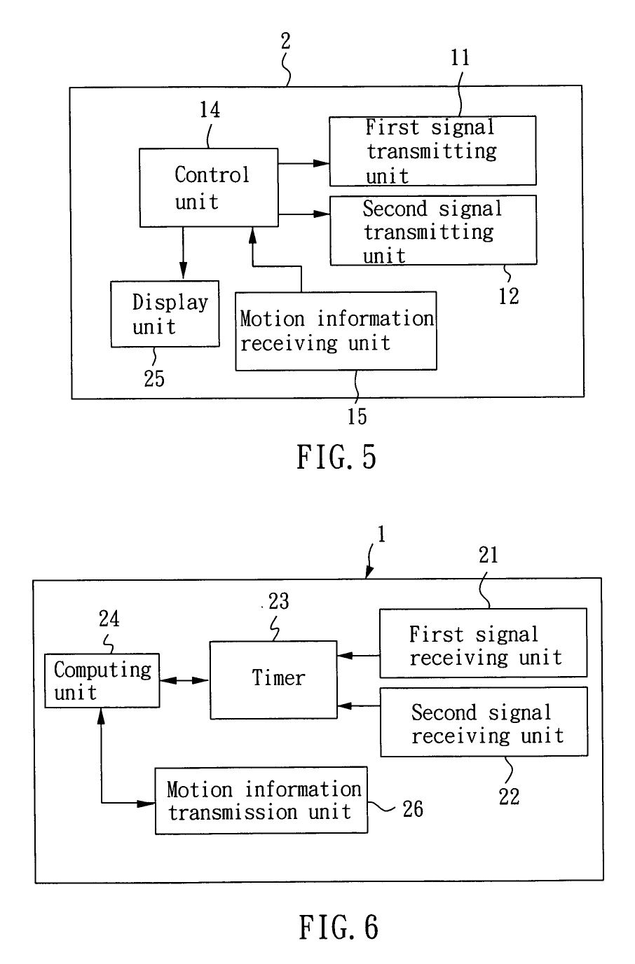

Please refer to FIG. 5 and FIG. 6. FIG. 5 is a function block drawing of a moving object according to a second embodiment of the present invention. FIG. 6 a function block drawing of a fixed object according to the second embodiment of the present invention. This embodiment is similar to the previous embodiment except that the fixed object 2 sends a plurality of first signals by way of electromagnetic waves, and second signals by way of ultrasonic waves, to the moving object 1, and the moving object 1 obtains the motion information according to the first signal and the second signal. As shown in the drawings, the fixed object 2 comprises a first signal transmitting unit 11, a second signal transmitting unit 12, a motion information receiving unit 15, a control unit 14 and a display unit 25. The first signal transmitting unit 11 is an RF transmitter, for sending a plurality of first signals; the first signals are sent via electromagnetic waves. The second signal transmitting unit 12 is an ultrasonic transmitter, for sending a plurality of second signals; the second signals are sent via ultrasonic waves. The first signal transmitting unit 11 and the second signal transmitting unit 12 respectively send the first signals and the second signals simultaneously. The motion information receiving unit 15 is used for receiving motion information, the control unit 14 processes the motion information, and the display unit 25 shows the results. The moving object 1 comprises a first signal receiving unit 21, a second signal receiving unit 22, a timer unit 23, a computing unit 24 and a motion information transmission unit 26. The first signal receiving unit 21 is used for receiving the first signal, and the second signal receiving unit 22 is used for receiving the second signal. The timer unit 23 starts to count when the first signal receiving unit 21 receives the first signal, and stops counting when the second signal receiving unit 22 receives the corresponding second signal. The computing unit 24 reads the time differences Δtᵢ, and obtains a relative distance between the moving object 1 and the fixed object 2, and the speed of the moving object 1 by way of the same equations described above. The motion information transmission unit 26 sends the motion information to the motion information receiving unit 15 for display by the display unit 25 of the motion information of the fixed object 2.

Although the present invention has been explained in relation to its preferred embodiment, it is to be understood that many other possible modifications and variations can be made without departing from the spirit and scope of the invention as hereinafter claimed.

1. A real-time object motion detection system comprising a first object and a second object in relative movement, wherein:
the first object sequentially sends a plurality of signal pairs at continuous time points, every signal pair comprising a first signal and a corresponding second signal, and a first propagation speed of the first signal is faster than a second propagation speed of the second signal; and
the second object receives the plurality of first signals and second signals, wherein after receiving one first signal, the second object starts to count until receiving the corresponding second signal to obtain a time difference, and then utilizes the time difference to calculate a relative movement distance and speed.

2. The system as claimed in claim 1, wherein the first signal is an electromagnetic wave signal and the second signal is an ultrasonic wave signal.

3. The system as claimed in claim 2, wherein the first object has a first signal transmitting unit and a second signal transmitting unit for respectively sending the first signal and the second signal.

4. The system as claimed in claim 2, wherein the second object has a first signal receiving unit and a second signal receiving unit for respectively receiving the first signal and the second signal.

5. The system as claimed in claim 4, wherein the second object has a timer unit for calculating a time difference between receiving the first signal and receiving the corresponding second signal.

6. The system as claimed in claim 5, wherein the second object has a computing unit utilizing the following equations to obtain the relative movement distance and speed:
Lᵢ₌V′×tᵢ,
and
V=(Lᵢ−Lᵢ₋ₗ)/Δtᵢ,
where Lᵢ is a distance between the first object and the second object at time tᵢ, V′ is a propagation speed of the second signal, Δtᵢ is a time difference calculated by the timer unit at time tᵢ, and V is a relative speed between the first object and the second object.

7. The system as claimed in claim 6, wherein the first object is a fixed object and the second object is a moving object.

8. The system as claimed in claim 7, wherein the fixed object has a display unit and the moving object has a motion information transmission unit for sending the relative movement distance and speed to the fixed object for being displayed on the display unit.

9. The system as claimed in claim 6, wherein the first object is a moving object and the second object is a fixed object.

10. The system as claimed in claim 9, wherein the fixed object has a display unit for displaying the relative movement distance and speed.

11. A moving objecting detection method for detecting relative motion information between a first object and a second object, the method comprising the steps of:
(A) the first object sequentially sending a plurality of signal pairs at continuous time points, every signal pair comprising a first signal and a corresponding second signal, and a first propagation speed of the first signal being faster than a second propagation speed of the second signal;
(B) the second object receiving the plurality of first signals and second signals, wherein after receiving one first signal, the second object starts to count until receiving the corresponding second signal to obtain a time difference; and
(C) the second object utilizing the time difference to calculate the motion information.

12. The method as claimed in claim 11, wherein the motion information includes a relative moving distance and a moving speed.

13. The method as claimed in claim 12, wherein in step (A), the first signal is an electromagnetic wave signal and the second signal is an ultrasonic wave signal.

14. The method as claimed in claim 13, wherein in step (C), the moving distance and the moving speed are obtained by the following equations:
Lᵢ=V′×tᵢ,
and
V=(Lᵢ−Lᵢ₋₁)/Δtᵢ,
where Lᵢ is a distance between the first object and the second object at time tᵢ, V′ is a propagation speed of the second signal, Δtᵢ is a time difference calculated by the timing unit at time tᵢ, and V is a relative speed of the first object and the second object.

15. The method as claimed in claim 14, wherein the first object is a fixed object and the second object is a moving object.

16. The method as claimed in claim 15, further comprises the step of:
(D) the moving object sending the relative movement distance and speed to the fixed object for display.

17. The method as claimed in claim 14, wherein the first object is a moving object and the second object is a fixed object.

18. The method as claimed in claim 17, further comprises the step of:
(E) the fixed object displaying the relative movement distance and speed.
